(19) United States
(12) Patent Application Publication
(10) Pub. No.: US 2022/0090733 A1
(43) Pub. Date: Mar. 24, 2022

(54) APPARATUS FOR STORING A LIGHTER FOR A JAR CANDLE AND METHOD OF USE

(71) Applicant: Michael James Baier, II, Duluth, GA (US)

(72) Inventor: Michael James Baier, II, Duluth, GA (US)

(21) Appl. No.: 17/461,992

(22) Filed: Aug. 30, 2021

Related U.S. Application Data
(60) Provisional application No. 63/072,096, filed on Aug. 28, 2020.

(51) Int. Cl. F16M 13/02; F21V 35/00

(52) U.S. Cl. CPC F16M 13/022; F21V 35/006

(57) ABSTRACT

Implementations of an apparatus for storing a lighter for a jar candle (a “storage apparatus”) and a method of use are provided. In some implementations, the storage apparatus comprises a storage or holder portion and a handle or hanger portion. In some implementations, a method of using the storage apparatus comprises attaching the storage apparatus to a jar candle and placing a lighter in the storage apparatus such that the storage apparatus stores or otherwise holds the lighter while the storage apparatus is attached to the jar candle.

### CROSS REFERENCE TO RELATED APPLICATION

This application claims the benefit of U.S. Patent Application Ser. No. 63/072,096, which was filed on Aug. 28, 2020, and is incorporated herein by reference in its entirety.

### TECHNICAL FIELD

This disclosure relates to implementations of an apparatus for storing a lighter for a jar candle and a method of use.

### BACKGROUND

Jar candles, such as shown in FIG. 1, are popular. For example, jar candles are often placed in various locations throughout a home, office, or other places for aesthetics and scent. Jar candles are usually lit with a lighter or similar device, such as shown in FIG. 2. However, a lighter can often become misplaced or otherwise not readily accessible for lighting a jar candle when needed. Furthermore, there does not exist an apparatus for storing a lighter so that it does not get misplaced and it stays readily accessible for lighting a jar candle when needed.

### BRIEF DESCRIPTION OF THE DRAWINGS

FIG. 1 illustrates an example existing jar candle.

FIG. 2 illustrates an example existing lighter.

FIGS. 3A-3D illustrate an implementation of an example storage apparatus according to the present disclosure.

FIGS. 4A and 4B illustrate another implementation of an example storage apparatus according to the present disclosure.

FIGS. 5A-5D illustrate another implementation of an example storage apparatus according to the present disclosure.

FIGS. 6A-6I illustrate another implementation of an example storage apparatus according to the present disclosure.

FIGS. 7A-7I illustrate another implementation of an example storage apparatus according to the present disclosure.

### DETAILED DESCRIPTION

Implementations of an apparatus for storing a lighter for a jar candle (a “storage apparatus”) and a method of use are provided. In some implementations, the storage apparatus comprises a storage or holder portion and a handle or hanger portion.

In some implementations, the storage apparatus is configured to store or otherwise hold a lighter.

In some implementations, the storage apparatus is configured to attach to a jar candle.

In some implementations, the storage apparatus is configured to store a lighter while attached to a jar candle.

In some implementations, the storage apparatus is configured to store a lighter while attached to a jar candle such that the lighter is conveniently available for use to light the jar candle.

In some implementations, the storage apparatus is configured to store a lighter while attached to a jar candle such that the lighter does not get misplaced and the lighter stays readily accessible for lighting the jar candle when needed.

In some implementations, the storage apparatus may be configured to allow the use of a cover, lid, or top of a jar candle to close and open the jar candle while the storage apparatus s attached to the jar candle and further used (e.g., to hold a lighter).

In some implementations, the storage apparatus may be configured to use as described herein with a jar candle further or alternately with a suitable smoking device, such as a Hookah, bong, etc.

In some implementations, a method of using the storage apparatus comprises attaching the storage apparatus to a jar candle and placing a lighter in the storage apparatus such that the storage apparatus stores or otherwise holds the lighter while the storage apparatus is attached to the jar candle.

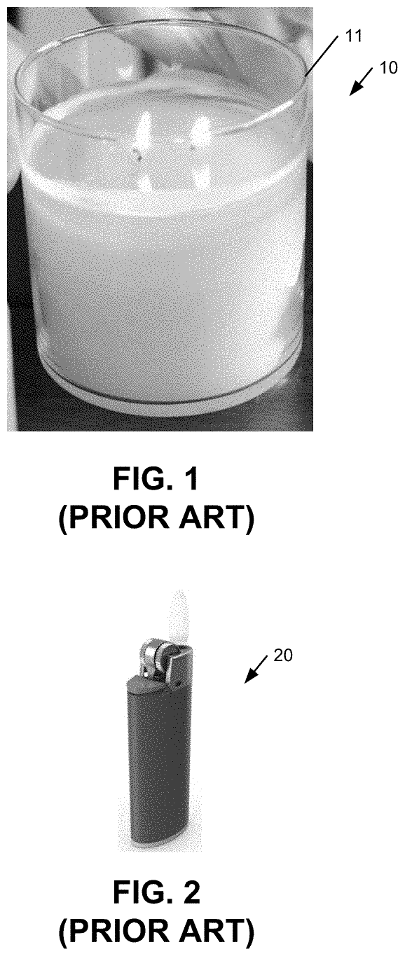

Jar candles 10, such as shown in FIG. 1, are popular. For example, jar candles 10 are often placed in various locations throughout a home, office, or other places for aesthetics and scent. As shown in FIG. 1, jar candles 10 may include a lip portion 11 at or near the opening for decorative appearance and/or for engagement with a cover, lid, or top of the jar candle 10.

Jar candles 10 are usually lit with a lighter 20 or similar device, such as shown in FIG. 2. However, a lighter 20 can often become misplaced or otherwise not readily accessible for lighting a jar candle 10 when needed.

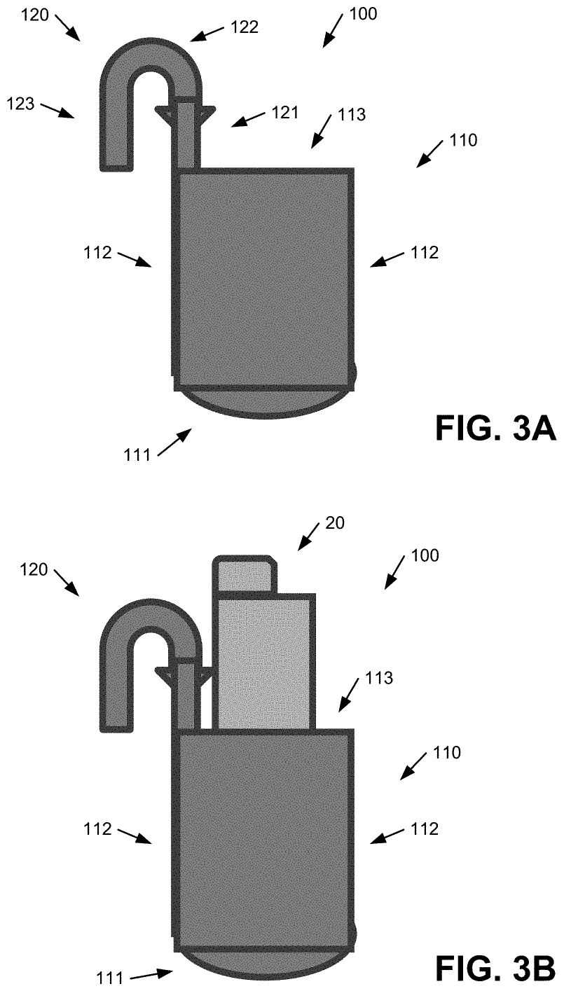

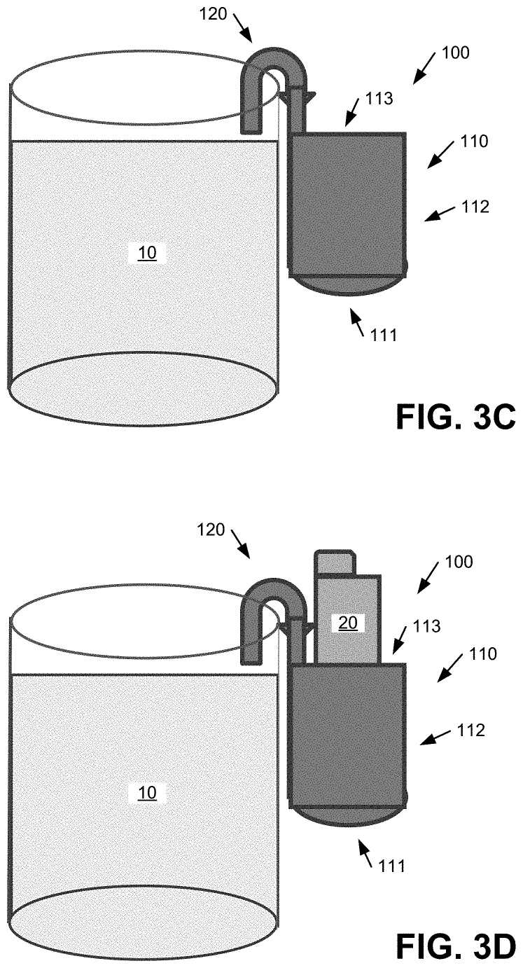

FIGS. 3A-3D illustrate an implementation of an example apparatus for storing a lighter for a jar candle (a “storage apparatus”) 100 according to the present disclosure. As shown in FIG. 3A, in some implementations, the storage apparatus 100 comprises a storage or holder portion 110 and a handle or hanger portion 120.

As shown in FIG. 3A, in some implementations, the storage portion 110 may be generally cup shaped. For example, in some implementations, the storage portion 110 may comprise a bottom 111, one or more sides 112, and an opening 113.

As shown in FIG. 3A, in some implementations, the bottom 111 is positioned on the storage portion 110 such that the bottom 111 positions and/or faces generally downward when the storage apparatus 100 is used. In some implementations, the bottom 111 is positioned generally opposite the opening 113 of the storage portion 110.

In some implementations, the bottom 111 may be in any other suitable position on the storage portion 110.

As shown in FIG. 3A, in some implementations, the bottom 111 may be generally flat. In some implementations, the bottom 111 may be generally concave or dome shaped. In some implementations, the bottom 111 may be any other suitable shape.

As shown in FIG. 3B, in some implementations, the bottom 111 is configured to support a lighter 20 that is stored or held in the storage portion 110. In some implementations, the bottom 111 may be configured to provide any other suitable features.

As shown in FIG. 3A, in some implementations, the side 112 extends from or between the bottom 111 to the opening 113.

In some implementations, the side 112 is positioned on the storage portion 110 such that the side 112 faces generally sideward and/or horizontal when the storage apparatus 100 is used. In some implementations, the side 112 may be in any other suitable position on the storage portion 110.

As shown in FIG. 3A, in some implementations, the side 112 may be generally curved. For example, in some implementations, the side 112 may be generally cylindrical.

As introduced above, in some implementations, the storage portion 110 may comprise more than one side 112 (not shown). For example, in some implementations, the storage portion 110 may comprise a plurality of flat sides 112 positioned in a generally triangular, rectangular, etc. shape.

In some implementations, the side(s) 112 may be any other suitable shape.

As shown in FIG. 3B, in some implementations, the side 112 is configured to support a lighter 20 that is stored or held in the storage portion 110. In some implementations, the side 112 is configured to generally encircle or otherwise surround a lighter 20 that is stored in the storage portion 110.

In some implementations, the side 112 may be configured to provide any other suitable features.

As shown in FIG. 3A, in some implementations, the opening 113 is positioned on the storage portion 110 such that the opening 113 positions and/or faces generally upward when the storage apparatus 100 is used. In some implementations, the opening 113 is positioned generally opposite the bottom 111 of the storage portion 110.

In some implementations, the opening 113 may be in any other suitable position on the storage portion 110.

As shown in FIG. 3A, in some implementations, the opening 113 may be generally formed by the side 112. For example, in some implementations, the opening 113 may be generally formed by the end or edge of the side 112 that is opposite the bottom 111.

In some implementations, the opening 113 may be formed in any other suitable way.

As shown in FIG. 3A, in some implementations, the opening 113 may be generally circular. In some implementations, the opening 113 may be generally flat. In some implementations, the opening 113 may be any other suitable shape.

As shown in FIG. 3B, in some implementations, the opening 113 is configured to receive a lighter 20 that is stored or held in the storage portion 110. In some implementations, the opening 113 is configured to support a lighter 20 that is stored in the storage portion 110. In some implementations, the opening 113 may be configured to provide any other suitable features.

In some implementations, the storage portion 110 may be any other suitable shape. In some implementations, the storage portion 110 may comprise any other suitable components.

As shown in FIG. 3B, in some implementations, the storage portion 110 is configured to store or otherwise hold a lighter 20.

As shown in FIG. 3C, in some implementations, the storage portion 110 is configured to attach to a jar candle 10 by the handle portion 120.

As shown in FIG. 3D, in some implementations, the storage portion 110 is configured to store a lighter 20 while attached to a jar candle 10 by the handle portion 120.

In some implementations, the storage portion 110 may be configured to provide any other suitable features.

As shown in FIG. 3A, in some implementations, the handle portion 120 may be generally hook shaped and/or U-shaped. For example, in some implementations, the handle portion 120 may comprise a first portion 121, a second portion 122, and a third portion 123. In some implementations, the handle portion 120 may have an open handle shape, as described more below.

As shown in FIG. 3A, in some implementations, the first portion 121 extends from the storage portion 110. For example, in some implementations, the first portion 121 extends from the side 112 of the storage portion 110 at or adjacent to the opening 113.

In some implementations, the first portion 121 may extend from any other suitable position of the storage portion 110.

As shown in FIG. 3A, in some implementations, the first portion 121 extends from or between the storage portion 110 to the second portion 122. For example, in some implementations, the first portion 121 extends generally straight from the storage portion 110 to the second portion 122. In some implementations, the first portion 121 extends generally upward from the storage portion 110 to the second portion 122 when the storage apparatus 100 is used.

In some implementations, the first portion 121 may extend from the storage portion 110 to the second portion 122 in any other suitable way.

In some implementations, the first portion 121 may be any suitable shape. For example, as shown in FIG. 3A, in some implementations, the first portion 121 may be elongated. In some implementations, the first portion 121 may be rectangular. In some implementations, the first portion 121 may be cylindrical.

In some implementations, the first portion 121 may be any other suitable shape.

As shown in FIG. 3A, in some implementations, the second portion 122 extends from or between the first portion 121 to the third portion 123. For example, in some implementations, the second portion 122 extends generally curved concave upward, e.g. in an inverted U-shape, from the first portion 121 to the third portion 123 when the storage apparatus 100 is used.

In some implementations, the second portion 122 extends generally curved concave upward such that each end of the second portion 122 extends generally downward to the first portion 121 and the third portion 123 respectively when the storage apparatus 100 is used. In some implementations, the second portion 122 may extend from the first portion 121 to the third portion 123 in any other suitable way.

In some implementations, the second portion 122 may be any suitable shape. For example, as shown in FIG. 3A, in some implementations, the second portion 122 may be rectangular. In some implementations, the second portion 122 may be cylindrical.

In some implementations, the second portion 122 may be any other suitable shape.

As shown in FIG. 3A, in some implementations, the third portion 123 extends from the second portion 122. For example, in some implementations, the third portion 123 extends generally straight from the second portion 122. In some implementations, the third portion 123 extends generally downward from the second portion 122 when the storage apparatus 100 is used.

In some implementations, the third portion 123 extends from the second portion 122 generally adjacent and/or parallel to the first portion 121. In some implementations, the third portion 123 may extend from the second portion 122 in any other suitable way.

In some implementations, the third portion 123 may be any suitable shape. For example, as shown in FIG. 3A, in some implementations, the third portion 123 may be elongated. In some implementations, the third portion 123 may be rectangular. In some implementations, the third portion 123 may be cylindrical.

In some implementations, the third portion 123 may be any other suitable shape.

In some implementations, the handle portion 120 may be any other suitable shape. In some implementations, the handle portion 120 may comprise any other suitable components.

As shown in FIG. 3C, in some implementations, the handle portion 120 is configured to attach the storage apparatus 100 to a jar candle 10. For example, in some implementations, the handle portion 120 has an open handle shape, such as the general hook shape and/or U-shape described above. In some implementations, the handle portion 120 has an open handle shape such that the handle portion 120 can be placed or otherwise positioned over the edge of a jar candle 10.

In some implementations, the handle portion 120 is configured to support the storage portion 110 when the storage apparatus 100 is attached to a jar candle 10.

As shown in FIG. 3D, in some implementations, the handle portion 120 is configured to support the storage portion 110 when the storage apparatus 100 is attached to a jar candle 10 and storing or holding a lighter 20.

In some implementations, the handle portion 120 may be configured to provide any other suitable features.

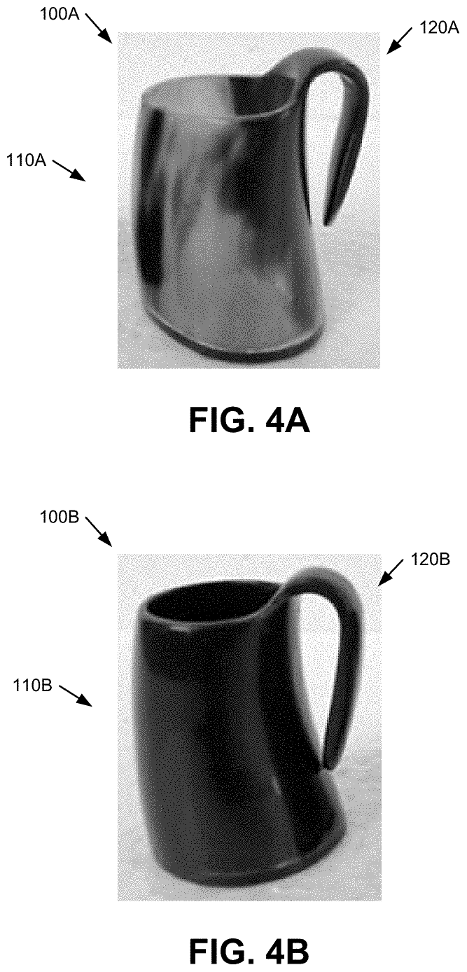

FIGS. 4A and 4B illustrate another implementation of an example storage apparatus 100A, 100B (collectively referred to below as the “storage apparatus 100”) according to the present disclosure. In some implementations, the storage apparatus 100A, 100B is generally the same or similar to the storage apparatus 100 described herein for FIGS. 3A-3D. For example, as shown in FIGS. 4A and 4B respectively, in some implementations, the storage apparatus 100A, 100B comprises a storage portion 110A, 110B and a handle portion 120A, 120B that are generally the same or similar to the storage portion 110 and handle portion 120 of the storage apparatus 100 of FIGS. 3A-3D.

Furthermore, in some implementations, the storage apparatus 100A, 100B is configured to store a lighter 20 while attached to a jar candle 10 the same or similar to the storage apparatus 100 of FIGS. 3A-3D.

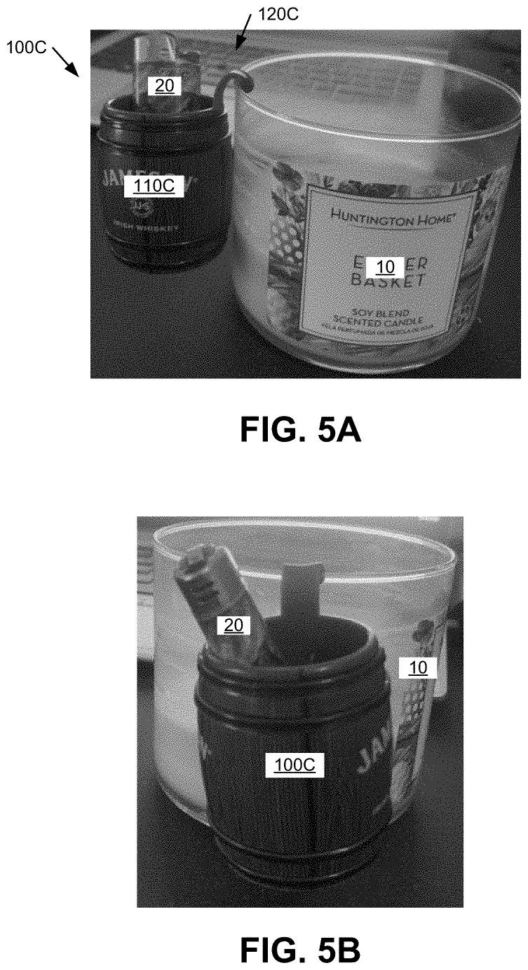

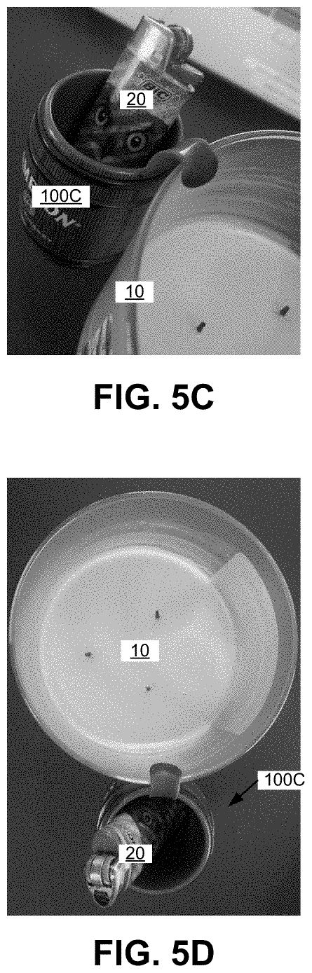

FIGS. 5A-5D illustrate another implementation of an example storage apparatus 100C (collectively referred to below as the “storage apparatus 100”) according to the present disclosure. In some implementations, the storage apparatus 100C is generally the same or similar to the storage apparatus 100 described herein for FIGS. 3A-3D. For example, as shown in FIG. 5A, in some implementations, the storage apparatus 100C comprises a storage portion 110C and a handle portion 120C that are generally the same or similar to the storage portion 110 and handle portion 120 of the storage apparatus 100 of FIGS. 3A-3D.

Furthermore, as shown in FIGS. 5A-5D, in some implementations, the storage apparatus 100C is configured to store a lighter 20 while attached to a jar candle 10 the same or similar to the storage apparatus 100 of FIGS. 3A-3D.

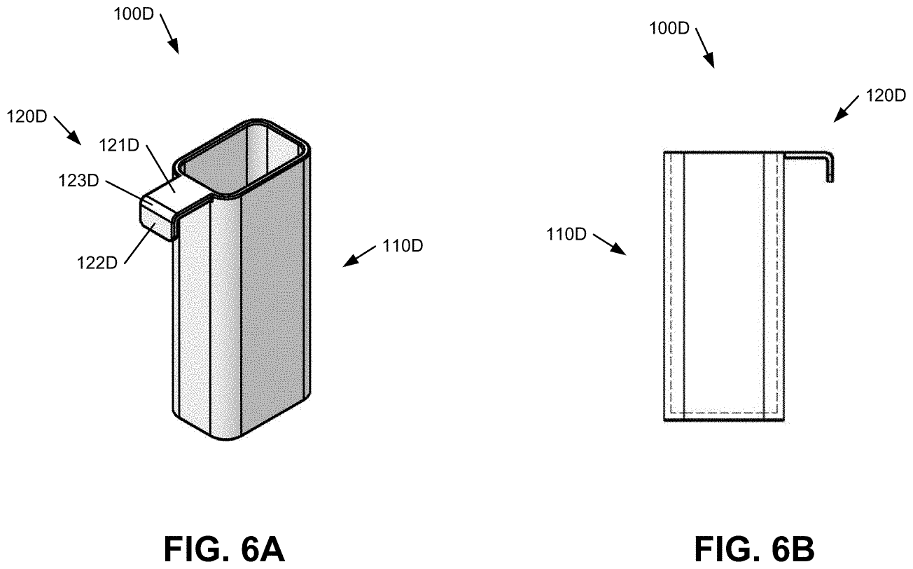

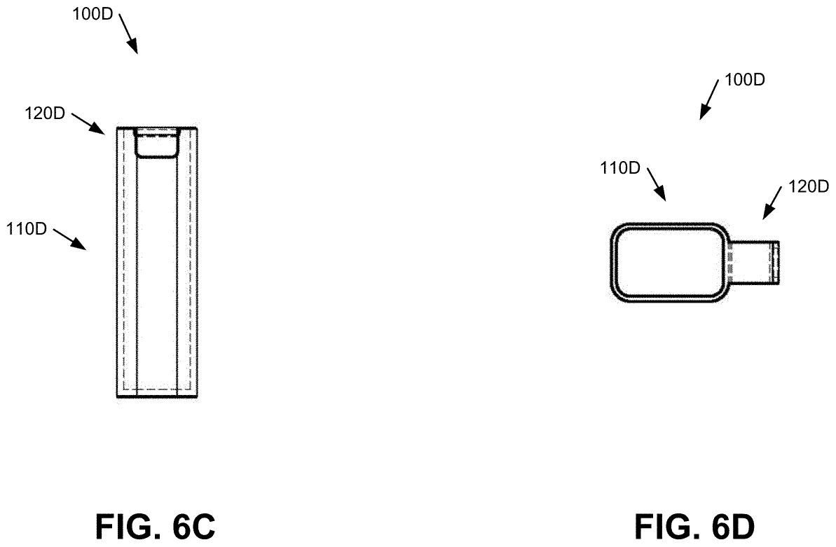

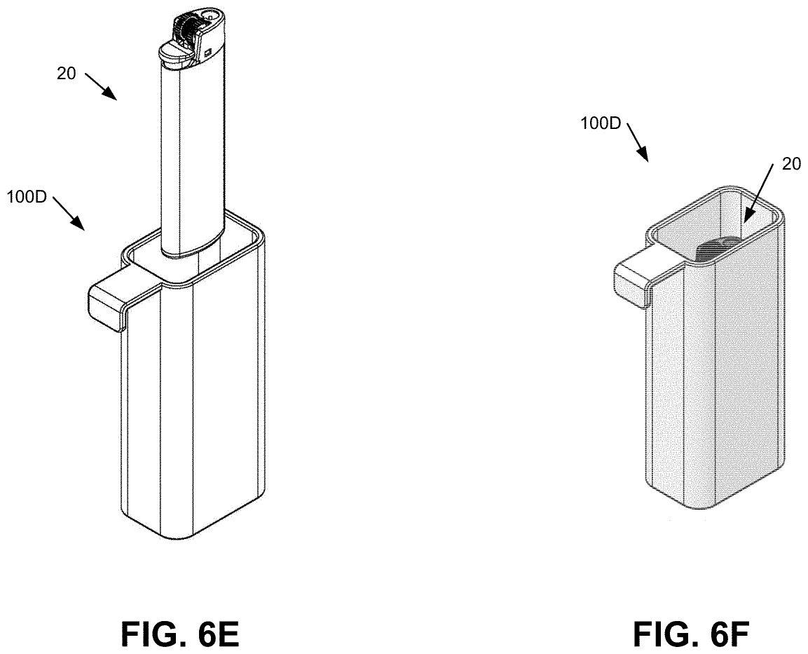

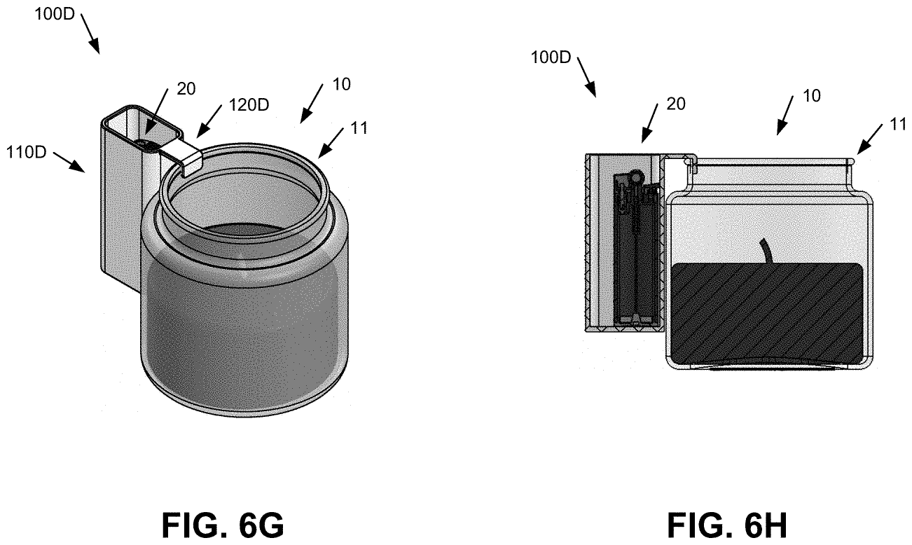

FIGS. 6A-6I illustrate another implementation of an example storage apparatus 100D (collectively referred to below as the “storage apparatus 100”) according to the present disclosure. In some implementations, the storage apparatus 100D is generally the same or similar to the storage apparatus 100 described herein for FIGS. 3A-3D, except as further described below. For example, as shown in FIG. 6A, in some implementations, the storage apparatus 100D comprises a storage portion 110D and a handle portion 120D that are generally the same or similar to the storage portion 110 and handle portion 120 of the storage apparatus 100 of FIGS. 3A-3D.

Furthermore, as shown in FIGS. 6G-6I, in some implementations, the storage apparatus 100D is configured to store a lighter 20 while attached to a jar candle 10 the same or similar to the storage apparatus 100 of FIGS. 3A-3D.

Additionally, as shown in FIG. 6A, in some implementations, the handle portion 120D of the storage apparatus 100D comprises a first portion 121D and a second portion 122D, and may further comprise a third portion 123D.

As shown in FIGS. 6A and 6G, in some implementations, the first portion 121D extends generally horizontal from the storage portion 110D to the second portion 122D. In some implementations, the second portion 122D extends generally downward from the first portion 121D.

As shown in FIGS. 6A and 6G, in some implementations, the third portion 123D may extend generally diagonal and/or curved between the first portion 121D and the second portion 122D.

As shown in FIGS. 6A and 6G-6I, in some implementations, the first portion 121D is configured to extend (e.g., in length, shape, and/or direction) from the storage portion 110D to the second portion 122D and/or the third portion 123D such that the storage portion 110D positions or rests against the jar of a jar candle 10 when the storage apparatus 100D is used. In some implementations, the first portion 121D is further configured to extend such that a lighter 20 positions or stands vertically or upright in the storage portion 110D when the storage apparatus 100D is used.

As shown in FIGS. 6A and 6G-6I, in some implementations, the second portion 122D is configured to extend (e.g., in length, shape, and/or direction) from the first portion 121D and/or the third portion 123D such that the storage portion 110D positions or rests against the jar of a jar candle 10 when the storage apparatus 100D is used. In some implementations, the second portion 122D is further configured to extend such that the storage apparatus 100D positions and/or attaches stabily and/or securely to a jar candle 10 when the storage apparatus 100D is used.

In some implementations, the second portion 122D is further configured to extend such that a lighter 20 positions or stands vertically or upright in the storage portion 110D when the storage apparatus 100D is used.

As shown in FIGS. 6A and 6G-6I, in some implementations, the third portion 123D may be configured to extend (e.g., in length, shape, and/or direction) from the first portion 121D to the second portion 122D such that the handle portion 120D positions and/or engages stabily and/or securely to the jar (e.g., to the lip portion 11) of a jar candle 10 when the storage apparatus 100D is used. In some implementations, the second portion 122D may also or alternately be further configured to extend (e.g., in length, shape, and/or direction) such that the handle portion 120D positions and/or engages stabily and/or securely to the jar (e.g., to the lip portion 11) of a jar candle 10 when the storage apparatus 100D is used.

In some implementations, the third portion 123D may be further configured to extend such that the storage portion 110D positions or rests against the jar of a jar candle 10 when the storage apparatus 100D is used. In some implementations, the third portion 123D may be further configured to extend such that a lighter 20 positions or stands vertically or upright in the storage portion 110D when the storage apparatus 100D is used.

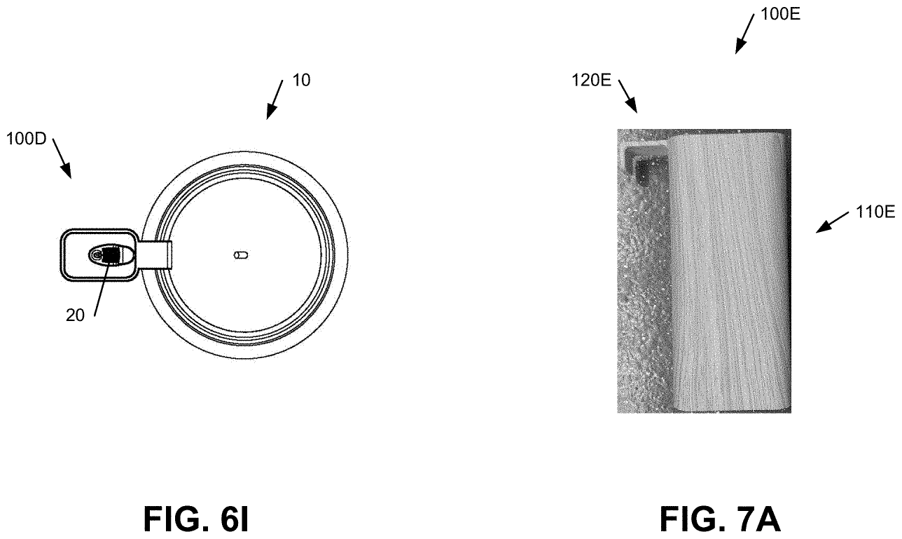

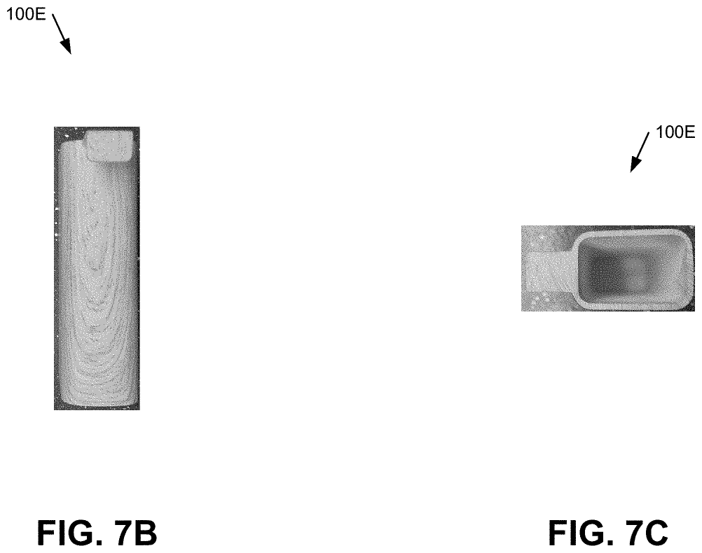

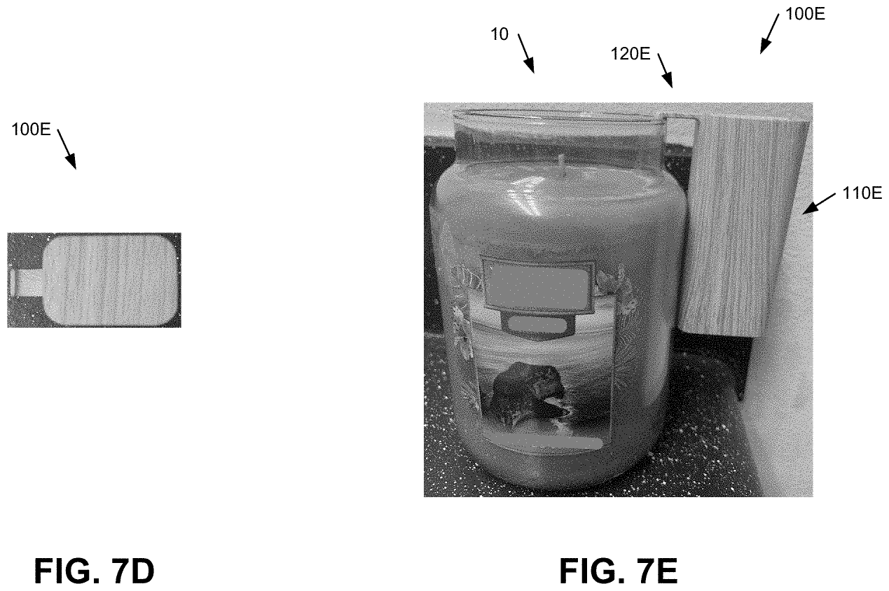

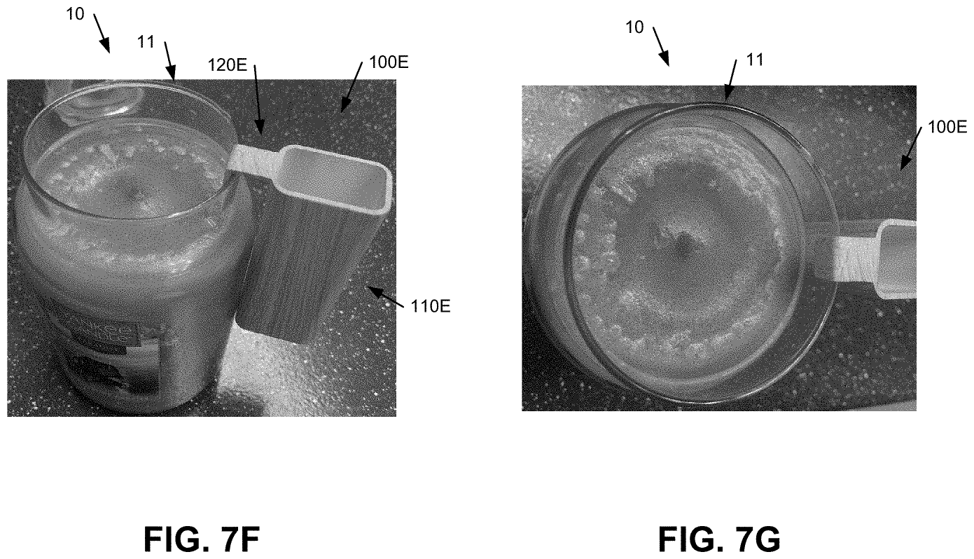

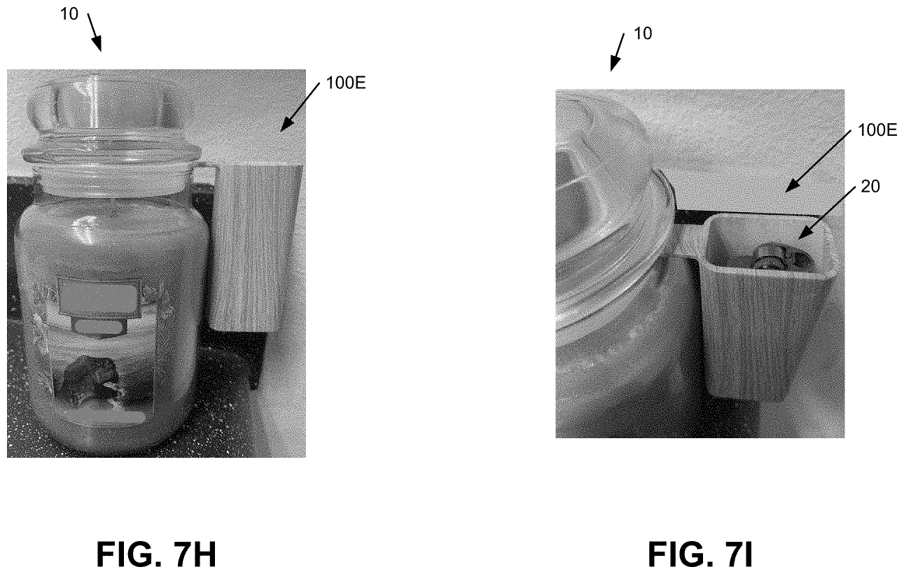

FIGS. 7A-7I illustrate another implementation of an example storage apparatus 100E (collectively referred to below as the “storage apparatus 100”) according to the present disclosure. In some implementations, the storage apparatus 100E is generally the same or similar to the storage apparatus 100D described above for FIGS. 6A-6I. For example, as shown in FIG. 7A, in some implementations, the storage apparatus 100E comprises a storage portion 110E and a handle portion 120E that are generally the same or similar to the storage portion 110D and handle portion 120D of the storage apparatus 100D of FIGS. 6A-6I.

Furthermore, as shown in FIGS. 7E-7I, in some implementations, the storage apparatus 100E is configured to store a lighter 20 while attached to a jar candle 10 the same or similar to the storage apparatus 100 of FIGS. 6A-6I.

Additionally, as shown in FIGS. 7H and 7I, in some implementations, the handle portion 120E (e.g., the second portion 122E and/or the third portion 123E) of the storage apparatus 100E may be configured (e.g., sized, shaped, etc.) such that a cover, lid, or top of a jar candle 10 can still be used to close and open the jar candle 10 while the storage apparatus 100E is attached to the jar candle 10 and further used (e.g., to hold a lighter 20).

As shown in FIGS. 3B, 5A-5D, 6E-6I, and 7I, in some implementations, the storage apparatus 100 is configured to store or otherwise hold a lighter 20.

As shown in FIGS. 3C, 5A-5D, 6G-6I, and 7E-7I, in some implementations, the storage apparatus 100 is configured to attach to a jar candle 10.

As shown in FIGS. 3D, 5A-5D, 6G-6I, and 7I, in some implementations, the storage apparatus 100 is configured to store a lighter 20 while attached to a jar candle 10.

In some implementations, the storage apparatus 100 is configured to store a lighter 20 while attached to a jar candle 10 such that the lighter 20 is conveniently available for use to light the jar candle 10.

In some implementations, the storage apparatus 100 is configured to store a lighter 20 while attached to a jar candle 10 such that the lighter 20 does not get misplaced and the lighter 20 stays readily accessible for lighting the jar candle 10 when needed.

In some implementations, the storage apparatus 100 may be configured to allow the use of a cover, lid, or top of a jar candle 10 to close and open the jar candle 10 while the storage apparatus 100 is attached to the jar candle 10 and further used (e.g., to hold a lighter 20).

In some implementations, the storage apparatus 100 may be configured to use as described herein with a jar candle 10 further or alternately with a suitable smoking device, such as a Hookah, bong, etc.

In some implementations, the storage apparatus 100 may be configured to provide any other suitable features.

In some implementations, the storage apparatus 100 may be configured to use in any other suitable way. For example, in some implementations, the storage apparatus 100 may be configured to store or otherwise hold any other suitable item while attached to a jar candle 10. In some implementations, the storage apparatus 100 may be configured to store a lighter 20 while attached to any other suitable item.

In some implementations, the storage apparatus 100 comprises any suitable dimensions. For example, in some implementations, the storage apparatus 100 (e.g., the holder portion 110) may be approximately 3 inches in height or length, approximately 1.5 inches in width, and approximately 1 inch in depth.

In some implementations, the storage apparatus 100 may be less than approximately 3 inches in height. In some implementations, the storage apparatus 100 may be greater than approximately 3 inches in height.

In some implementations, the storage apparatus 100 may be less than approximately 1.5 inches in width. In some implementations, the storage apparatus 100 may be greater than approximately 1.5 inches in width.

In some implementations, the storage apparatus 100 may be less than approximately 1 inch in depth. In some implementations, the storage apparatus 100 may be greater than approximately 1 inch in depth.

In some implementations, the storage apparatus 100 is composed of any suitable materials. For example, in some implementations, the storage apparatus 100 may be composed of a ceramic material.

In some implementations, the storage apparatus 100 may be composed of a plastic material. In some implementations, the storage apparatus 100 may be composed of a metallic material.

In some implementations, the storage apparatus 100 may be composed of a suitable fire retardant material, such as acrylonitrile-butadlene-styrene (ABS).

In some implementations, the storage apparatus 100 can have any suitable appearance, such as the example appearances shown in the figures. For example, the storage apparatus 100 may be or have any suitable color, texture, pattern, surface treatment, etc.

In some implementations, an example method of using the apparatus for storing a lighter for a jar candle (the “storage apparatus”) 100, with respect to the above-described figures, comprises attaching the storage apparatus 100 to a jar candle 10, such as shown in FIGS. 3C, 5A, 6G, and 7E. As shown in FIGS. 3C, 3D, 5A-5D, 6G-6I, and 7E-7I, in some implementations, the storage apparatus 100 is attached to the jar candle 10 by placing or otherwise positioning the handle portion 120 over the edge of the jar candle 10.

In some implementations, the handle portion 120D is positioned and/or engaged stabily and/or securely to the jar (e.g., to the lip portion 11) of the jar candle 10.

As shown in FIGS. 3D, 5A-5D, 6G-6I, and 7I, in some implementations, the method comprises placing or otherwise positioning a lighter 20 in the storage portion 110 of the storage apparatus 100. In some implementations, the lighter 120 is placed in the storage portion 110 such that the storage apparatus 100 stores or otherwise holds the lighter 20 while the storage apparatus 100 is attached to the jar candle 10.

In this way, in some implementations, the storage apparatus 100 stores or otherwise holds a lighter 20 while attached to a jar candle 10 such that the lighter 20 is conveniently available for use to light the jar candle 10. Furthermore, in this way, in some implementations, the storage apparatus 100 stores a lighter 20 while attached to a jar candle 10 such that the lighter 20 does not get misplaced and the lighter 20 stays readily accessible for lighting the jar candle 10 when needed.

In some implementations, the method may further comprise using a cover, lid, or top of the jar candle 10 to close and open the jar candle 10 while the storage apparatus 100 is attached to the jar candle 10.

In some implementations, the above described method(s) used with a jar candle 10 may be further or alternately used with a suitable smoking device, such as a Hookah, bong, etc. or with any other suitable device, items, etc.

The figures, including photographs and drawings, comprised herewith may represent one or more implementations of the apparatus for storing a lighter for a jar candle and the method of use.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A storage apparatus for storing a lighter comprising:
a storage portion comprising a bottom portion and sidewalls configured to form an elongated open container; and
a handle portion extending from a sidewall wherein the handle portion is an open handle configured to receive a portion of an upper edge of a candle jar so that a portion of the handle rests on the upper edge of the candle jar and a sidewall rests on a portion of the outer surface of the candle jar.

2. A storage apparatus for storing a lighter comprising:
a storage portion comprising a bottom portion and sidewalls configured to form an elongated open container; and
a handle portion extending from a sidewall wherein the handle portion includes a hook portion configured to receive a portion of an upper edge of a candle jar so that a portion of the handle portion rests on the upper edge of the candle jar and a sidewall rests on a portion of the outer surface of the candle jar.

3. The storage apparatus of claim 2 where the hook portion is bent.

4. The storage apparatus of claim 2 where the hook portion is curved.

5. A candle jar and storage apparatus comprising:
a candle jar having an upper edge encircling an opening of the candle jar;
a storage apparatus comprising a storage portion comprising a bottom portion and sidewalls configured to form an elongated open container; and
a handle portion extending from a sidewall wherein the handle portion is an open handle configured to receive a portion of an upper edge of a candle jar so that a portion of the handle rests on the upper edge of the candle jar and a sidewall rests on a portion of the outer surface of the candle jar, wherein
a portion of the handle rests on the upper edge of the candle jar and a sidewall rests on a portion of the outer surface of the candle jar.

6. The candle jar and storage apparatus of claim 5 further comprising a lighter housed in the storage portion.

7. A method of using the storage apparatus of claim 1 comprising
placing the storage apparatus on a candle jar using the handle; and
placing a lighter in the storage portion.

8. A method of using the storage apparatus of claim 1 comprising
placing the storage apparatus on an apparatus using the handle; and
placing a lighter in the storage portion.

9. A method of using the storage apparatus of claim 2 comprising
placing the storage apparatus on a candle jar using the handle portion; and
placing a lighter in the storage portion.
